(19) United States
(12) Patent Application Publication
(10) Pub. No.: US 2013/0340248 A1
(43) Pub. Date: Dec. 26, 2013

(54) DEVICE AND METHOD FOR CONNECTING A CABLE AND A CONNECTOR ENSURING THE CONTINUITY OF THE ELECTROMAGNETIC SHIELDING

(71) Applicant: Francois Dusailly, Saint Remy Les Chevreuse (FR)

(72) Inventor: Francois Dusailly, Saint Remy Les Chevreuse (FR)

(73) Assignee: GETELEC, Buc (FR)

(21) Appl. No.: 13/985,097

(22) PCT Filed: Feb. 14, 2012
(86) PCT No.: PCT/FR2012/050318

§ 371 Date: Sep. 11, 2013

(30) Foreign Application Priority Data
Feb. 16, 2011 (FR) 1151253
Feb. 10, 2012 (FR) 1251261

(51) Int. Cl. H01R 43/04

(52) U.S. Cl. CPC H01R 43/04
USPC 29/753

(57) ABSTRACT

A device for joining the end (3a) of a shielded coaxial cable (3) and a metal connector (10), the cable including a peripheral metal braid (4) and an axial conductor (2), and including a conductive overmoulding (5) that at least partially surrounds the end of the shielded cable (3) and one end of the connector (10), the overmoulding making contact with the metal braid (4) and the connector (10), so as to ensure the continuity of the electromagnetic shielding of the connection. A method for producing such a connection is also described.

The present invention relates to a method and device making it possible to connect a shielded coaxial cable and a metal connector, while ensuring the continuity of the electromagnetic shielding of the assembly.

It is known that coaxial electrical cables are generally electromagnetically protected by a shield produced using a metal braid that surrounds an axial conductor. It is, however, difficult to ensure the continuity of the shielding between said cables and the shielded enclosures of the systems to which they are connected by means of a connector, in particular at the junction between the cable and the connector at the end of the cable. It is known to shield this junction using metal enclosures in contact with the shield and the connector, but this type of shielding has many drawbacks:

the shielding is generally not completely sealed against waves,

the shielding obtained is not lasting over time, for example due to a separation of the metal enclosure and the braid and/or a lack of contact due to oxidation,

the shielding is not watertight.

The invention therefore more particularly aims to resolve this problem by proposing a method and a device that are simple and inexpensive, in particular making it possible to ensure the continuity of the electromagnetic shielding at the junction between the end of a shielded coaxial cable and a connector to which the cable is connected.

To that end, the invention proposes a device for producing the junction between the end of a shielded coaxial cable and a metal connector, said cable including a peripheral metal braid and an axial conductor, said device being able to comprise a conducting overmolding at least partially surrounding the end of the shielded cable and one end of said connector, said overmolding being in contact with said metal braid and said connector, so as to ensure the continuity of the electromagnetic shielding of the junction.

Overmolding a junction between the end of a cable and a metal connector using a conducting material makes it possible to obtain 360° grounding, ensuring very effective electromagnetic shielding of that junction against high and low frequency electromagnetic disruptions.

Advantageously, the conducting overmolding may include an intrinsically conductive polymer material.

Alternatively, it may include a nonconductive polymer material charged with conducting particles.

One thus benefits both from the encasing and adhesive properties of the material and its conductive properties, thereby resulting in omnidirectional shielding of the junction between the cable and the connector.

Advantageously, the conductive particles may comprise an intrinsically inoxidizable or relatively inoxidizable metal, and/or a metal coated with a conducting layer protecting against oxidation.

It is preferable in this junction for the metal braid to be in direct contact with at least part of the metal contactor. To that end, the end of the shielded coaxial cable is engaged in an end channel of said conductor, and the end of the metal braid and said channel are in contact in one of the following relative positions:

the end of the metal braid of the cable may abut axially against the end walls of the channel,

or the end of the metal braid may at least partially cover the walls of said channel,

or the walls of said channel may at least partially cover the end of the metal braid.

The shielding braid of the cable may abut against the end walls of said channel of the connector in which the end of the cable engages. According to one alternative embodiment, the end of the shielding braid may cover said walls. According to another alternative embodiment of the invention, the end of the shielding braid is inserted with the end of the cable into said channel of the connector.

Such a connection between a coaxial cable and a connector has several advantages:

it does not include metal parts that may separate and/or be subject to oxidation, and is therefore more reliable and more durable,

it cannot be disassembled, which prohibits “repairing” the connection, with the consequences related thereto in terms of reliability,

it is sealed against waves,

it is watertight, which allows underwater applications.

The invention also relates to a method for connecting a coaxial cable and a metal connector while ensuring the continuity of the electromagnetic shielding of the assembly, which may comprise the following steps:

stripping one end of the coaxial cable so as to expose the metal shielding braid,

partially engaging said end of the cable in an end channel of the connector so as to leave a portion of the metal braid visible and put the metal braid and the walls of the channel in contact,

using a conducting material to overmold the visible part of the braid of said end of the cable and at least part of said channel of the connector so that the contact area between the end of the cable and the connector is covered with said material.

Embodiments of the invention will be described below, as non-limiting examples, in reference to the appended drawings, in which:

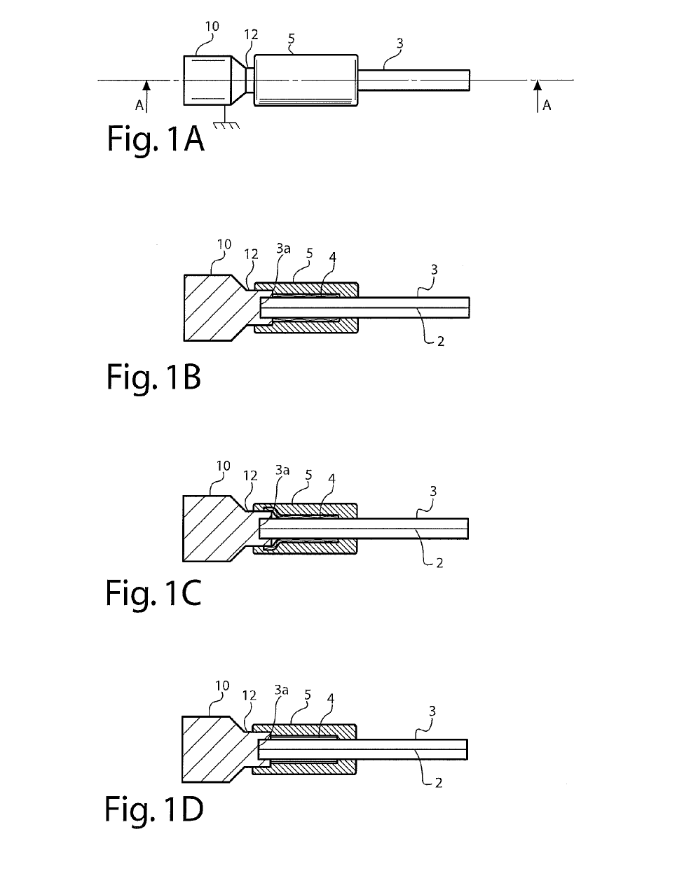

FIG. 1A is an elevation view of a junction between a cable and a connector with overmolding,

FIG. 1B is a diagrammatic axial cross-sectional view A-A of the junction between a cable and a connector with overmolding,

FIG. 1C is an axial cross-sectional view A-A of a first alternative of a junction between a cable and a connector with overmolding,

FIG. 1D is an axial cross-sectional view A-A of a second alternative junction between a cable and a connector with overmolding.

In this example, as shown in particular in FIGS. 1A to 1D, the device according to the invention comprises:

the end 3a of the coaxial cable 3, said cable being shielded using a metal braid 4 surrounding at least one axial electric conductor 2 (in broken lines); the metal braid 4 may in particular be made from copper, aluminum or steel;

a metal conductor 10 that can be connected to a system that is electrically powered and that itself is electromagnetically protected; this electrical connector includes an end channel 12 in which said end 3a of the shielded cable 3 engages;

the conducting overmolding 5 that overmolds the end 3a of the cable and part of the channel of the connector 10; this overmolding is advantageously done from a conducting material described below, so as to ensure 360° grounding guaranteeing the equipotentiality of the metal braid 4 and the connector 10; as shown in FIGS. 1A to 1D, the overmolded part 5 has a substantially cylindrical shape.

After having inserted the end 3a of the cable 3 in the free space of the channel 12, the metal braid 4 can:

abut against the end walls of the channel 12 of the connector 10, as shown in FIG. 1B;

cover the walls of the channel 12 of the connector 10, as shown in FIG. 1C;

be inserted into the space delimited by the walls of the channel 12 of the connector 10, as shown in FIG. 1D.

The overmolded part 5 covers the end 3a of the cable 3 and therefore the metal braid 4, as well as at least part of the channel 12 of the connector 10, which advantageously makes it possible to ensure 360° grounding.

The overmolding 5 may be done:

either from an injectable polymer material or a thermoplastic material such as Santoprene™, filled with conductive particles,

or an organic intrinsically conducting polymer (ICP) material, the goal being to achieve a resistivity of approximately 5 mΩ/cm.

Advantageously, the overmolding may include a binder comprising a silicone elastomer material or an elastomeric plastic, which is preferably injectable.

Advantageously, the overmolding may include a filler of conductive particles comprised between x and y %, preferably approximately 80% so as to achieve the aforementioned low resistivity.

In the case of a non-conductive polymer binder, the conductive particles may be:

Silver particles,

Graphite-covered Nickel particles,

Silver-covered Copper particles, or

Silver-covered Aluminum particles.

The use of a noble metal such as Silver makes it possible to avoid oxidation. These particles have a diameter comprised between 20 and 40 μm.

1. A device for producing the junction between the end (3a) of a shielded coaxial cable (3) and a metal connector (10), said cable including a peripheral metal braid (4) and an axial conductor (2),
characterized in that it comprises a conducting overmolding (5) at least partially surrounding the end of the shielded cable (3) and one end of said connector (10), said overmolding being in contact with said metal braid (4) and said connector (10), so as to ensure the continuity of the electromagnetic shielding of the junction.

2. The device according to claim 1, characterized in that said conducting overmolding (5) includes an intrinsically conductive polymer material.

3. The device according to claim 1, characterized in that said conducting overmolding (5) includes a nonconductive polymer material charged with conducting particles.

4. The device according to claim 3, characterized in that said conductive particles comprise an intrinsically inoxidizable or relatively inoxidizable metal, and/or a metal coated with a conducting layer protecting against oxidation.

5. The device according to claim 3, characterized in that said conductive particles are chosen from the list comprising:
Silver particles,
Graphite-covered Nickel particles,
Silver-covered Copper particles, or
Silver-covered Aluminum particles.

6. The device according to claim 3, characterized in that said conductive particles have a diameter comprised between 20 and 40 μm.

7. The device according to claim 2, characterized in that the overmolding includes a binder comprising a silicone elastomer material or an elastomeric plastic, which is preferably injectable.

8. The device according to claim 2, characterized in that the overmolding includes a filler of conductive particles comprised between x and y %, preferably approximately 80%.

9. The device according to claim 1, characterized in that the end (3a) of the shielded coaxial cable (3) is engaged in an end channel (12) of said connector (10), and in that the end of the metal braid (4) and said channel (12) are in contact in one of the following relative positions:
the end of the metal braid (4) of the cable (3) abuts axially against the end walls of the channel (12),
or the end of the metal braid (4) at least partially covers the walls of said channel (12),
or the walls of said channel (12) at least partially covers the end of the metal braid (4).

10. A method for connecting a coaxial cable (3) and a metal connector (10) while ensuring the continuity of the electromagnetic shielding of the assembly, characterized in that it comprises the following steps:
stripping one end (3a) of the coaxial cable (3) so as to expose the axial conductor (2) and the metal shielding braid (4),
partially engaging said end (3a) of the cable (3) in an end channel (12) of the connector (10) so as to leave a portion of the metal braid (4) visible and put the metal braid (4) and the walls of the channel (12) in contact,
using a conducting material (5) to overmold the visible part of the braid (4) of said end (3a) of the cable (3) and at least part of said channel (12) of the connector (10) so that the contact area between the end of the cable (3) and the connector (10) is covered with said material.

11. The device according to claim 4, characterized in that said conductive particles are chosen from the list comprising:
Silver particles,
Graphite-covered Nickel particles,
Silver-covered Copper particles, or
Silver-covered Aluminum particles.

12. The device according to claim 4, characterized in that said conductive particles have a diameter comprised between 20 and 40 μm.

13. The device according to claim 5, characterized in that said conductive particles have a diameter comprised between 20 and 40 μm.
